(19) United States
(12) Patent Application Publication
(10) Pub. No.: US 2025/0044524 A1
(43) Pub. Date: Feb. 6, 2025

(54) PLUG SYSTEM FOR SEWER INSPECTION SYSTEMS AND/OR SEWER MAINTENANCE SYSTEMS

(71) Applicant: iPEK International GmbH, Sulzberg (DE)

(72) Inventors: Andreas Becherer, Waltenhofen (DE); Michael Kress, Kempten (DE); Hannes Endler, Marktoberdorf (DE)

(21) Appl. No.: 18/735,658

(22) Filed: Jun. 6, 2024

(30) Foreign Application Priority Data
Jun. 6, 2023 (EP) 23177632.9

(51) Int. Cl. G02B 6/38; F16L 55/28; F16L 101/10; F16L 101/30; H01R 13/645

(52) U.S. Cl. CPC G02B 6/3817; G02B 6/3853; H01R 13/6456; F16L 55/28; F16L 2101/10; F16L 2101/30

(57) ABSTRACT

A connector is provided for a sewer inspection and/or maintenance system for operatively coupling a first optical waveguide arranged in the connector to a second optical waveguide arranged in a mating connector, wherein
the connector comprises a connector housing in which a recess is formed for receiving an optical waveguide housing,
the first optical waveguide is arranged in the optical waveguide housing, wherein the first optical waveguide is fixed in the optical waveguide housing.

### CROSS-REFERENCE TO RELATED APPLICATIONS

This application claims priority to European Patent Application Serial No. EP23177632.9, filed Jun. 6, 2023, the entire disclosure of which is hereby incorporated herein by reference in its entirety.

### FIELD OF THE INVENTION

The invention relates to a connector for a sewer inspection and/or maintenance system having an optical waveguide arranged in the connector and also to a connector system consisting of two connectors.

### BACKGROUND OF THE INVENTION

Until now, sewer inspection and maintenance systems have been implemented using copper transmission links. However, these have a limited bandwidth, which means that high-resolution video signals can only be transmitted with great effort and only in a compressed form. There is usually a separable electrical interface between the crawler of a sewer inspection and maintenance system and the cable leading out of the sewer. These connector interfaces are robustly designed for applications in pipe and sewer systems.

Due to the ever-increasing bandwidth required for data transmission (e.g., for higher-resolution image and/or video data), the transmission link is increasingly being switched over from copper to fiber optic. The requirements for the separable connection between the cable and the crawler remain the same. Fiber optic connectors with direct contact between the fibers do not meet these requirements. In addition, such a connection places very high demands on manufacturing tolerances (axial and radial offsets must be in the single-digit μm range). With normal manufacturing methods, it is not practicable to produce . . . fiber optic connectors with such manufacturing tolerances. In addition, such fiber optic connectors are very sensitive to contamination.

To avoid the problems mentioned above with fiber optic connectors, the fiber optic link can be converted into a copper transmission link before the coupling, so that the connector interface itself is designed as an electrical interface. However, this approach has the disadvantage that appropriate electronics must be placed between the fiber optic link and the connector interface (usually in the connector housing), which results in larger connector housings. Larger connector housings can in turn reduce the possible range of applications, for example when sliding systems are to be used for pipes with small diameters.

### OBJECT OF THE INVENTION

The object of the present invention is therefore to provide an optical waveguide connector for sewer inspection and/or maintenance systems which at least partially avoids the disadvantages mentioned above and makes possible an improved and secure coupling of a cable to an optical waveguide for data transmission.

### Solution According to the Invention

This object is achieved by a connector and a connector system according to the independent claims. Advantageous embodiments of the invention are set forth in the specific dependent claims.

Accordingly, a connector is provided for a sewer inspection and/or maintenance system for operatively coupling a first optical waveguide arranged in the connector to a second optical waveguide arranged in a mating connector, wherein
the connector comprises a connector housing in which a recess is formed for receiving an optical waveguide housing,
the first optical waveguide is arranged in the optical waveguide housing, wherein the first optical waveguide is fastened in the optical waveguide housing,
the first optical waveguide on the coupling side
comprises a lens through which light can be coupled out of the first optical waveguide or into the first optical waveguide, or
comprises a contact surface which corresponds to a contact surface of the second optical waveguide arranged in the mating connector, and
the optical waveguide housing is accommodated in the recess.

“On the coupling side” here refers to the end or side of the connector that faces the mating connector for coupling the connector with the mating connector, i.e., the free end of the optical waveguide arranged in the connector. In other words,
a lens is arranged at the free end of the first optical waveguide arranged in the connector, via which lens light can be coupled out of the first optical waveguide or coupled into the first optical waveguide, or
the free end of the first optical waveguide arranged in the connector is designed as a contact surface which corresponds to a contact surface of the second optical waveguide arranged in the mating connector, wherein the optical signal transmission is effected via the contact surface.

By the first optical waveguide being fixed in the optical waveguide housing, the radial offset of the free end of the first optical waveguide relative to the free end of the second optical waveguide of the mating connector can be minimized or optimized, in particular when the connector housing of the connector can be coupled to the connector housing of the mating connector in a form-fitting manner in radial terms, i.e., the connector in the coupled state cannot be moved radially relative to the mating connector.

In one embodiment of the invention, the optical waveguide housing can be axially displaceable in the recess. The radial offset of the free end of the first optical waveguide relative to the free end of the second optical waveguide of the mating connector can thus be minimized or optimized. Together with the fixing of the first optical waveguide in the optical waveguide housing, not only the axial but also the radial offset of the free end of the first optical waveguide relative to the free end of the second optical waveguide of the mating connector can be minimized or optimized. The connector interface itself no longer needs to be designed as an electrical interface. In contrast to the very tight manufacturing tolerances, significantly broader tolerances are possible here without impairing the optical signal transmission.

A spring element acting on the optical waveguide housing can be arranged in the recess, with which the optical waveguide housing can be displaced axially (in the direction of the coupling side). In the coupled state of the connector, this ensures that the free end of the first optical waveguide or the lens arranged thereon does not exceed a predetermined axial distance from the second optical waveguide of the mating connector, or that in the coupled state this distance is minimized.

It can be advantageous if the optical waveguide housing is held in the recess so as to be rotationally locked. This applies in particular if the free ends of the first and second optical waveguides are designed as contact surfaces that are not perpendicular to the longitudinal axis of the optical waveguide (e.g., optical waveguides whose ends have a beveled edge). This ensures that the position of the opposing contact surfaces does not change when coupled.

In one embodiment of the invention, a first electrical conductor can (optionally) be arranged in the connector housing, which conductor can be coupled to a second electrical conductor arranged in the mating connector in order to take up a supply of electrical energy therewith. One and the same connector can be used not only for optical data transmission but also for the supply of electrical energy. The first electrical conductor can additionally or alternatively be used for data transmission (for example for data that require only a low bandwidth).

Alternatively to or in addition to the first electrical conductor, mechanical interfaces can also be provided in the connector housing which correspond to or can be coupled to corresponding mechanical interfaces in the mating connector. For example, a compressed air interface or a fluid interface can be provided in one and the same connector.

The first electrical conductor can have a coupling element (e.g., a pin) on the coupling side, which corresponds to a coupling element (e.g., a sleeve) of the second electrical conductor of the mating connector.

It can be advantageous if the connector is designed to be connected to the mating connector in a rotationally locked manner relative to the mating connector, wherein the connector housing has an anti-rotation device which corresponds to an anti-rotation device of the connector housing of the mating connector. On the one hand, this ensures that the connector and mating connector can only be coupled in such a way that the optical waveguide housings of the connector and the mating connector are correctly aligned with each other axially. Together with the rotationally locking arrangement of the optical waveguide housing in the recess of the connector housing, this ensures dependable optical data transmission. This also eliminates the need for complex sliding contacts for transmitting electrical energy, such as those required for connectors that can be rotated relative to one another.

In one embodiment of the invention, at least two recesses for receiving in each case an optical waveguide housing can be formed in the connector housing, wherein the at least two recesses are arranged offset from one another and wherein preferably at least one of the two recesses is not arranged coaxially in relation to the connector housing. A plurality of mutually independent optical transmission links can thus be realized with just one connector.

It can be advantageous if the connector housing is designed to be gas- and fluid-tight.

In one embodiment, it can be provided that the connector housing can be coupled in a gas- and fluid-tight manner to a connector housing of the mating connector. This prevents dirt or liquid from getting into the area of the optical coupling points during operation.

According to one embodiment of the invention, the lens can be a spherical lens adapted for beam expansion. Other forms of lenses that make a suitable beam expansion possible can also be used within the meaning of the present invention.

The invention further provides a connector system with a connector according to the invention and with a mating connector, wherein the mating connector is designed according to the connector according to the invention, wherein the connector, in particular the connector housing of the connector, can be coupled to the mating connector, in particular the connector housing of the mating connector, wherein the optical waveguide housings of the connector and of the mating connector are arranged in the respective connector housing such that, in the coupled state of the connector and the mating connector, the lenses of the optical waveguides or the contact surfaces of the optical waveguides are arranged relative to one another in such a way that optical data transmission can be carried out therewith.

### BRIEF DESCRIPTION OF THE FIGURES

Further details and features of the invention as well as specific, particularly advantageous embodiments of the invention will be apparent from the following description in conjunction with the drawing. In the figures:

FIG. 1 shows a connector and an associated mating connector of a connector system according to the invention in a perspective view;

FIG. 2 shows a sectional view (along the longitudinal axis) of a connector system according to the invention with optical waveguide housings that are not spring-mounted;

FIG. 3 shows a sectional view (along the longitudinal axis) of a connector system according to the invention with optical waveguide housings which are spring-mounted;

FIG. 4 shows an optical waveguide housing of a connector according to the invention in a perspective view (Figure (a)) and in a sectional view along the longitudinal axis (Figure (b)), and an enlarged view of the coupling-side end of the optical waveguide housing (Figure (c));

FIG. 5 shows an example of a specific use of a connector system according to the invention on a push rod of a sewer inspection system; and

FIG. 6 shows a further example of a specific use of a connector system according to the invention on a crawler of a sewer inspection system.

### DETAILED DESCRIPTION OF THE INVENTION

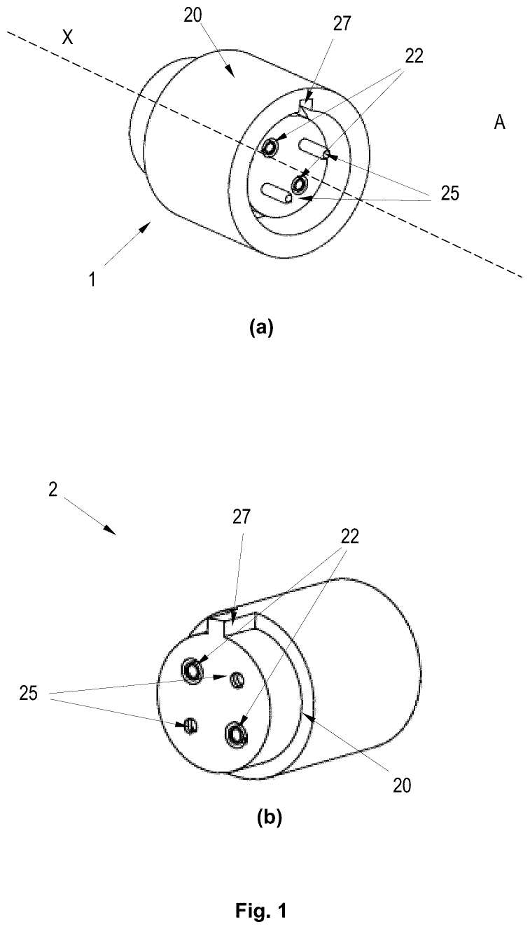

FIG. 1 shows a connector (Figure (a)) and an associated mating connector (Figure (b)) of a connector system according to the invention in a perspective view.

The connector 1 and the mating connector 2 are essentially designed such that they can be coupled to one another in such a way that between them an optical data transmission and, depending on the further design, also a transmission of electrical energy can be effected. In one embodiment of the invention, the connector 1 and the mating connector 2 can be detachably coupled.

The connector 1 and the mating connector 2 each have a connector housing 20 in which an optical waveguide housing 22 is arranged. In FIG. 1, the coupling-side end of the optical waveguide housing 22 can be seen. The coupling-side end is marked with the reference symbol “A” in FIG. 1.

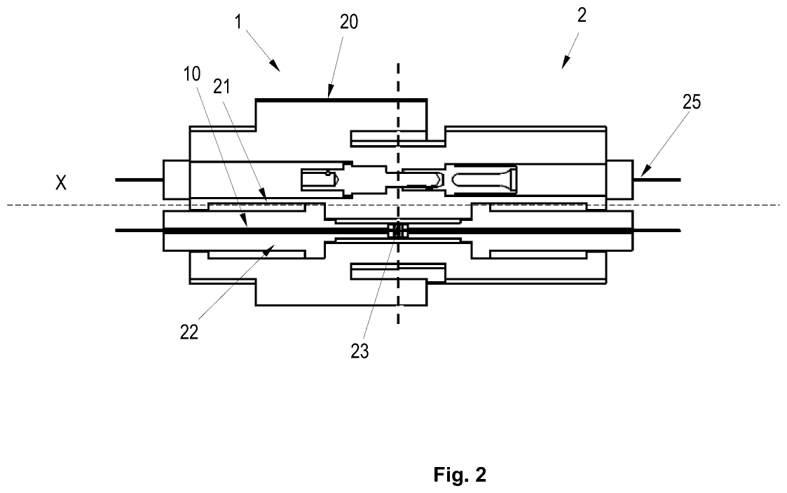

The optical waveguide housing 22 can be fixedly arranged in the connector housing 20. Alternatively, the optical waveguide housing 22 can be arranged in a recess provided for this purpose in the connector housing, wherein this recess and the optical waveguide housing are designed such that the optical waveguide housing can be moved in the recess in the axial direction (along the axis X) (as shown in Figure (b) of FIG. 2, for example).

An optical waveguide 10 is arranged in the optical waveguide housing 22, the free end of which is located at the coupling-side end A of the optical waveguide housing 22. The optical waveguide housing 22 is described in more detail with reference to FIG. 2.

The connector housings 20 can be designed such that they can be coupled together in a largely fluid-tight and/or gas-tight manner. During operation, when the connector 1 and the mating connector 2 are coupled, this prevents dirt or liquids from getting between them, which can affect the function, especially optical data transmission. For this purpose, it may be provided that a radially circumferential seal (not shown in FIG. 1) is provided on the coupling-side end A of the connector 1 and/or of the mating connector 2.

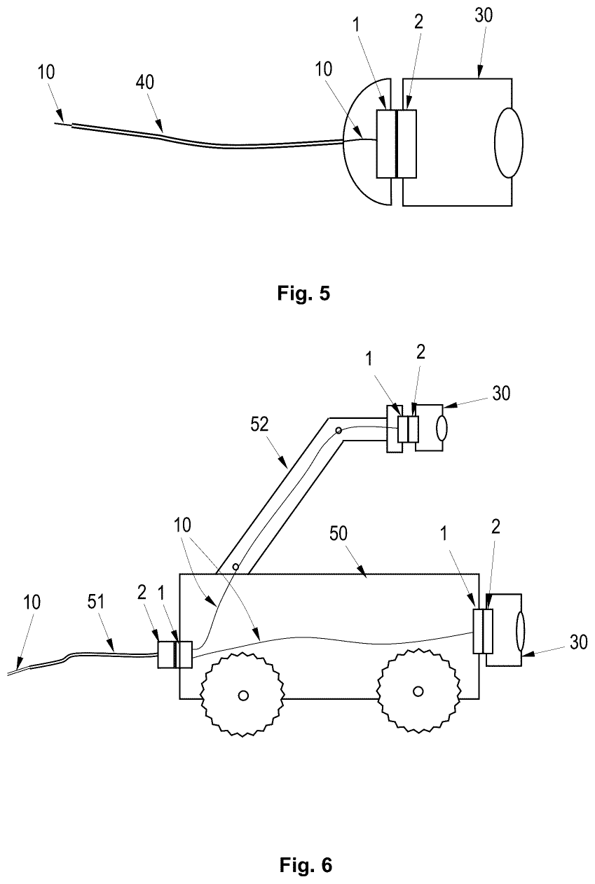

The connector system according to the invention, consisting of a connector 1 and a mating connector 2, can have a locking means by means of which the connector 1 can be locked to the mating connector 2 in order to prevent the connector 1 from unintendedly detaching from the mating connector 2. Particularly in the field of sewer inspection and/or maintenance, (axial) tensile forces can act on the connector system, which, without adequate locking, can lead to the connector becoming detached from the mating connector. According to the invention, the connector 1 can, for example, be arranged on a camera system and the mating connector 2 on a free end of a push rod (as shown in FIG. 5)—when the push rod is being pulled out of the sewer, without adequate locking the camera can become detached from the push rod, for example if the camera gets caught in the sewer. Advantageously, the locking mechanism can be designed such that when the two connectors are coupled, they are automatically locked, but undoing the connectors the locking mechanism requires them to be released manually.

In the embodiment of the connector system according to the invention shown in FIG. 1, in addition to the optical waveguide housing 22 electrical conductors 25 are also arranged in the housing 20, wherein the first electrical conductor 25.1 of the connector 1 can be operatively coupled to the second electrical conductor 25.2 of the mating connector 2. The electrical conductors can be provided for handling the power supply. Alternatively or additionally, the electrical conductors can also be used for data transmission. For example, it may be advantageous to use the optical waveguides for video data transmission requiring a high bandwidth and to use the electrical conductors for the transmission of simple sensor data. The coupling of the two electrical conductors 25.1, 25.2 can be effected via known coupling systems, for example by means of a pin and a correspondingly adapted sleeve, as shown in FIG. 1. The coupling of the electrical conductors is advantageously designed in such a way that it meets the requirements for explosion protection.

Alternatively, the coupling of the two electrical conductors 25.1, 25.2 can also be capacitive or inductive, depending on the requirements.

In addition to or as an alternative to the electrical conductors 25.1, 25.2, mechanical interfaces can also be provided, which, for example, make it possible to transfer compressed air or liquids from one connector 1 to the other connector 2.

FIG. 1 shows a connector system in which each connector has two optical waveguide housings so that two optical transmission links can be provided. According to the invention, it is also possible to provide only one optical waveguide housing in each connector—in this case, the optical waveguide housing can be arranged concentrically, i.e., on the longitudinal axis X in the connector housing. However, more than two optical waveguide housings can be provided in each case.

The number of optical waveguide housings in the two connectors and thus the number of optical waveguides do not have to be identical. For example, one connector may have two optical waveguide housings and the other connector may have only one optical waveguide housing. When coupling the two connectors, the two mutually corresponding optical waveguides can be used operatively, while the second optical waveguide of one connector is “dead.” This means that, for example, a universal connector can be provided on a crawler (as shown in FIG. 5), which connector has a plurality of optical waveguide housings and thus a plurality of optical waveguides to which connectors can be coupled which also have fewer optical waveguides. For example, different camera systems, which provide different numbers of video signals and which are in each case to transmit via separate optical transmission links, can thus be connected to the crawler.

The connector housings 20 can be designed such that, in the coupled state, they are secured against rotation (about the longitudinal axis X) relative to one another. For this purpose, corresponding anti-rotation devices 27 can be provided on the connector housings 20. One type of anti-rotation device, as shown in FIG. 1, consists of a nose projecting from one connector housing, which engages in a corresponding recess on the other connector housing. The anti-rotation device is advantageously designed in such a way that the two connectors can only be coupled together in one relative position to each other. On the one hand any rotation relative to each other is thus prevented. On the other hand, incorrect coupling of the two connectors is prevented, which is particularly important when a plurality of optical waveguide housings are arranged in the connector housings or when there is only one optical waveguide housing in the connector housings and this is not arranged concentrically. In the case of only one concentrically arranged optical waveguide housing and electrical conductors that interlock when coupled, an anti-rotation device may not be necessary.

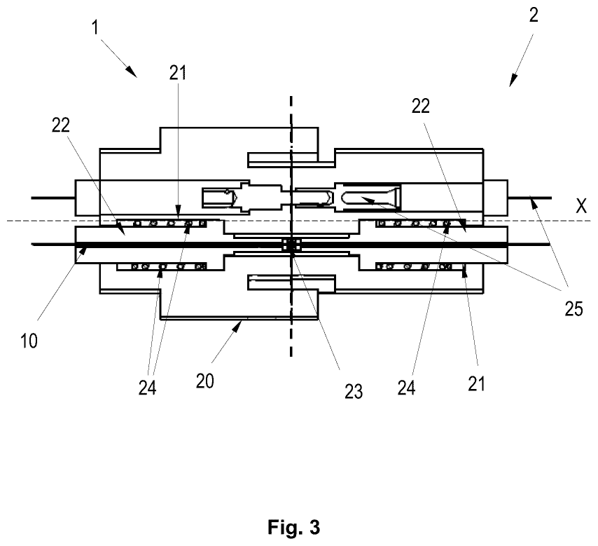

FIG. 2 and FIG. 3 each show sectional views (parallel to the longitudinal axis X) of two connector systems according to the invention with optical waveguide housings, wherein in FIG. 2 the optical waveguide housings are not spring-mounted and in FIG. 3 they are spring-mounted.

Visible here are the recesses 21 in the connector housings 20 in which recesses the optical waveguide housings 22 are arranged.

In the embodiment that is not spring-mounted (as shown in FIG. 2), it can be provided that the optical waveguide housing 22 is arranged fixedly, i.e., not movably, in the recess. However, this is only optional.

According to the embodiment shown in FIG. 3, the optical waveguide housing 22 is spring-mounted in the recess 21, wherein here a compression spring is arranged in the recess 21. The optical waveguide housing 22 is arranged in the recess 21 so as to be movable in the axial direction. The compression spring is arranged relative to the optical waveguide housing 22 in such a way that it can apply a spring force to the optical waveguide housing 22 which causes the optical waveguide housing to be pressed in the recess 21 in the direction of the coupling-side end A of the connector. The spring is dimensioned in such a way that it yields when a certain force is applied that acts counter to the spring force of the spring, so that the optical waveguide housing . . . in the recess 21 is moved in the opposite direction (counter to the spring force).

The provision of a compression spring has two main advantages:

Firstly, it ensures that the optical waveguide housings 22 do not exceed a certain minimum axial distance when the connectors are coupled together, which has a positive effect on the optical data transmission if lenses 23 are provided at the free ends of the optical waveguides.

Secondly, in the case of optical waveguides whose free ends are designed as contact surfaces for optical signal transmission, it can be ensured that the contact surfaces touch each other, regardless of any manufacturing tolerances of the connector housings, without the contact surfaces being damaged.

Spiral compression springs are shown in FIG. 3. According to the invention, other spring systems suitable for this purpose can also be provided.

Also shown in FIG. 2 and FIG. 3 are the two electrical conductors 25 shown in FIG. 1.

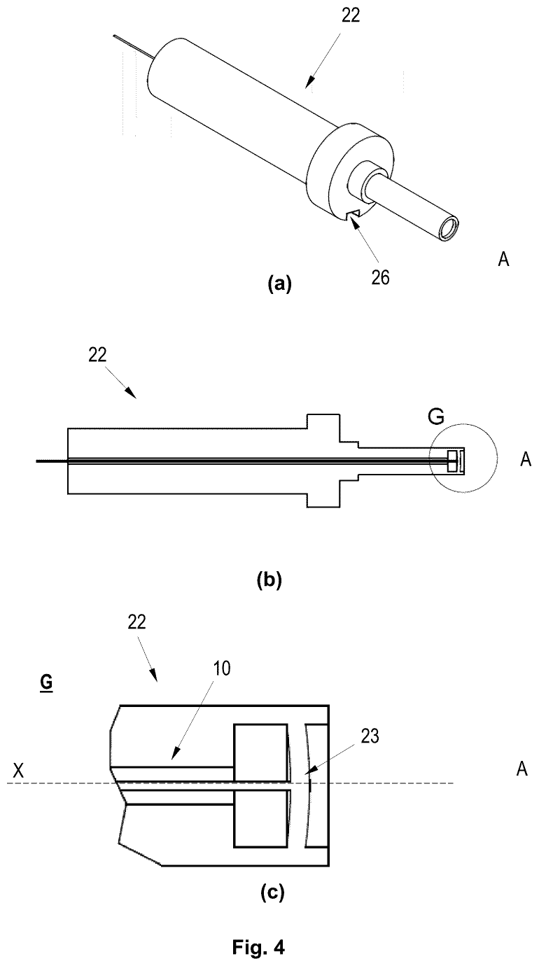

FIG. 4 shows an optical waveguide housing 22 of a connector according to the invention in a perspective view (Figure (a)) and in a sectional view along the longitudinal axis (Figure (b)), and an enlarged view of the coupling-side end of the optical waveguide housing (Figure (c)).

An optical waveguide 10 is fixedly arranged in the optical waveguide housing 22 and is guided into the optical waveguide housing at the rear. The free end of the optical waveguide 10 is located at the coupling-side end A.

In the embodiment shown in FIG. 4, a lens 23 is arranged at the coupling-side end A of the optical waveguide housing 22, which lens is operatively coupled to the free end of the optical waveguide 10. The lens is selected such that it has a suitable beam expansion to couple light out of the optical waveguide or to couple light into the optical waveguide.

Instead of a lens 23, the free end of the optical waveguide can also be designed as a contact surface. For example, a bevel cut can be provided. The contact surface is designed such that it corresponds to the contact surface of the other optical waveguide. In this context, “correspond” means that the contact surfaces of two coupled optical waveguides are designed and arranged relative to each other in such a way that optical data transmission can be carried out therewith.

The optical waveguide housing 22 can have an optional anti-rotation device 26, such as a recess (or projection) that corresponds to a projection (or recess) arranged in the recess 21 of the connector housing 20. The anti-rotation device prevents the optical waveguide housing 22 from rotating in the recess 21 of the connector housing 20. This is particularly advantageous if the free end of the optical waveguide is designed as a contact surface, wherein a rotation of the contact surface (around the longitudinal axis X) can lead to a disruption of the optical data transmission or even to damage of the optical waveguide.

FIG. 5 shows an example of a specific use of a connector system according to the invention on a push rod of a sewer inspection system.

A camera system 30 is arranged at the front end of a push rod 40, which is introduced into a sewer or pipe. According to the invention, the camera system 30 is coupled to the front end of the push rod via a connector system according to the invention. For this purpose, a connector 1 according to the invention is arranged at the front end of the push rod and a mating connector 2 according to the invention is arranged on the camera system.

The optical waveguide can be guided through the core of the push rod to the connector 1.

FIG. 6 shows another example of a specific use of a connector system according to the invention on a crawler of a sewer inspection system.

The crawler 50, which is brought into a sewer, has a camera system 30 at the front end, which is coupled to the crawler via a connector system according to the invention, wherein a connector 1 according to the invention is arranged on the crawler and a mating connector 2 according to the invention is arranged on the camera system 30.

The crawler here comprises a lifting system 52, at the free end of which a further camera system 30 is arranged, which is coupled to the lifting system 52 via a connector system according to the invention, wherein a connector 1 according to the invention is arranged on the lifting system and a mating connector 2 according to the invention is arranged on the camera system 30.

A cable 51 is attached to the rear of the crawler 50, which leads out of the sewer and is provided for optical data transmission. In addition, the cable 51 can also be provided for a power supply. The cable 51 is coupled to the crawler 50 via a connector system according to the invention, wherein a connector 1 according to the invention is arranged on the crawler and a mating connector 2 according to the invention is arranged on the cable 51.

The connector located on the rear of the crawler is connected via the optical waveguide 10 to the connector on the lifting system at one end and to the connector on the front of the crawler at the other end. In the application example shown in FIG. 5, it may be advantageous to provide two optical waveguide housings in the connector system arranged on the rear of the crawler, wherein the optical waveguide of one optical waveguide housing is connected to the connector on the lifting system and the optical waveguide of the other optical waveguide housing is connected to the connector on the front of the crawler. Accordingly, two optical waveguides can be provided in the cable 51 so that video signals from the camera on the lifting system can be optically transmitted via one optical waveguide and video signals from the camera on the front of the crawler can be optically transmitted via the other optical waveguide. The connectors on the lifting system and on the front of the crawler therefore need to have only one optical waveguide housing in each case.

With the connector system according to the invention it is also possible to transmit data bidirectionally via the optical waveguides.

The connector system according to the invention can be manufactured to be extremely robust. At the same time, requirements relating to manufacturing tolerances can be reduced without having a negative impact on the optical transmission, this being achieved by the anti-rotation devices and the spring-loaded mounting of the optical waveguide housings in the connector housings.

### REFERENCE SIGNS

A Coupling side or on the coupling side
X Axis
1 Connector
2 Mating connector.
10 Optical waveguide
10.1 First optical waveguide
10.2, Second optical waveguide
20 Connector housing
21 Recess in the connector housing 20
22 Optical waveguide housing in the recess 21
23 Lens at the coupling end of the optical waveguide 10.1, 10.2
24 Spring element in the recess 21
25 Electrical conductor
25.1 First electrical conductor
25.2 Second electrical conductor
26 Anti-rotation device on the optical waveguide housing 22
27 Anti-rotation device on the connector housing 20
30 Camera system
40 Push rod
50 Crawler
51 Cable
52 Lifting system

We claim:

1. A connector for a sewer inspection and/or maintenance system for operatively coupling a first optical waveguide arranged in the connector to a second optical waveguide arranged in a mating connector, wherein:
the connector comprises a connector housing in which a recess is formed for receiving an optical waveguide housing,
the first optical waveguide is arranged in the optical waveguide housing, wherein the first optical waveguide is fixed in the optical waveguide housing,
the first optical waveguide on the coupling side
comprises a lens through which the light
can be decoupled from the first optical waveguide, or
can be coupled into the first optical waveguide, or
comprises a contact surface which corresponds to a contact surface of the second optical waveguide arranged in the mating connector, and
the optical waveguide housing is accommodated in the recess.

2. The connector according to claim 1, wherein the optical waveguide housing is axially displaceable in the recess.

3. The connector according to claim 2, wherein a spring element acting on the optical waveguide housing is arranged in the recess, by means of which element the optical waveguide housing is axially displaceable.

4. The connector according to claim 1, wherein the optical waveguide housing is accommodated in the recess in a rotationally locked manner.

5. The connector according to claim 1, wherein, in the connector housing, a first electrical conductor is arranged which can be coupled to a second electrical conductor arranged in the mating connector in order to take up a supply of electrical energy thereby.

6. The connector according to claim 5, wherein, on the coupling side, the first electrical conductor has a coupling element which corresponds to a coupling element of the second electrical conductor.

7. The connector according to claim 1, wherein the connector is designed to be connected to the mating connector in a rotationally locked manner relative to the mating connector, wherein the connector housing has an anti-rotation device which corresponds to an anti-rotation device of the connector housing of the mating connector.

8. The connector according to claim 1, wherein at least two recesses are formed in the connector housing for receiving in each case an optical waveguide housing, wherein the at least two recesses are arranged non-coaxially and offset from one another.

9. The connector according to claim 1, wherein the connector housing is designed to be gas- and fluid-light.

10. The connector according to claim 1, wherein the connector housing can be coupled in a gas- and fluid-tight manner to a connector housing of the mating connector.

11. A connector system comprising:
a first connector and a second connector, wherein:
the first connector and second connector are each a type of connector for a sewer inspection and/or maintenance system for operatively coupling a first optical waveguide arranged in the type of connector to a second optical waveguide arranged in a mating connector, wherein:
the type of connector comprises a connector housing in which a recess is formed for receiving an optical waveguide housing,
the first optical waveguide is arranged in the optical waveguide housing, wherein the first optical waveguide is fixed in the optical waveguide housing,
the first optical waveguide on the coupling side:
comprises a lens through which the light
can be decoupled from the first optical waveguide, or
can be coupled into the first optical waveguide, or
comprises a contact surface which corresponds to a contact surface of the second optical waveguide arranged in the mating connector, and
the optical waveguide housing is accommodated in the recess; and
a connector housing of the first connector can be coupled to a connector housing of the second connector, wherein respective optical waveguide housings of the first connector and the second connector are arranged in their respective connector housings in such a way that, in the coupled state of the first connector and the second connector, respective lenses of the first and second connectors' optical waveguides or contact surfaces of the first and second connectors' optical waveguides are arranged relative to one another such that an optical data transmission between the first and second connector can be carried out via the respective optical waveguides.
